(19) United States
(12) Patent Application Publication
(10) Pub. No.: US 2005/0114776 A1
(43) Pub. Date: May 26, 2005

(54) Tutorial apparatus

(75) Inventors: Michael C. Wood, Orinda, CA (US); L. James Marggraff, Lafayette, CA (US); Patricia Krueger, Albany, CA (US); Cam Ryder, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/966,148

(22) Filed: Oct. 15, 2004

Related U.S. Application Data
(60) Provisional application No. 60/512,445, filed on Oct. 16, 2003.

(51) Int. Cl. G06F 3/00

(52) U.S. Cl. 715/709; 715/705; 715/707

(57) ABSTRACT

A tutorial apparatus is disclosed. The tutorial apparatus is to be operated by a user, and includes a processor unit and a memory unit coupled to the processor unit. The memory unit includes code for allowing the user to enter user-selected study material into the tutorial apparatus, code for forming a problem using the user-selected study material, and code for providing assistance in solving the problem formed using the user-selected study material.

### CROSS-REFERENCES TO RELATED APPLICATIONS

This patent application is a non-provisional of and claims the benefit of the filing date of U.S. patent application Ser. No. 60/512,445, filed on Oct. 16, 2003, which is herein incorporated by reference in its entirety for all purposes.

### BACKGROUND OF THE INVENTION

U.S. Pat. No. 5,203,705 describes an electronic spelling machine that compares an input term against a list of terms in memory and validates spelling and provides a set of terms, which may correspond to the input term if the input term is incorrect. The validated term or suggested term is provided with a locating indicia that permits the user to go to the page in a book where the definition or the meaning of the word may be found. Various word games are incorporated. A user determined list may be substituted for the main list of terms in order to enable the user to practice word games and thus learn the words based on a selected list of terms of significance to the user. For purposes of game playing, the words incorrectly used from the user list are biased in such a fashion that they are picked in a quasi-random fashion so that the words played incorrectly are selected with greater frequency than the words played correctly.

While the machine in the above-described patent is useful, improvements could be made. For example, the above-described machine is not able to provide the user with assistance if the user does not know how to spell a particular word. In addition, the above-described machine is not suitable for or remotely capable of teaching a complex subject such as math, let alone math using user-selected study material.

Other types of tutorial apparatuses may include computers. Commercially available software for computers can allow a user to select a specific skill level. The computer can then present problems for that skill level to the user. As the user tries to solve a problem, the computer can provide a help button for the user to select and receive feedback if the user has difficulty solving the problem.

A number of other improvements could be made to these types of tutorial apparatuses. For example, the problems presented by the computer are “pre-set” in the software. Although the user may choose a set of problems to study, the user cannot choose individual words to study. The user cannot use the computer to practice, for example, problems that the user has received as homework from the user's school. It would be desirable if the computer could provide for the ability to provide assistance with specialized problems that the user might receive for homework.

Embodiments of the invention address the above-described problems and other problems individually and collectively.

### SUMMARY OF THE INVENTION

Embodiments of the invention are directed to tutorial apparatuses, computer readable media, and methods.

One embodiment of the invention is directed to a tutorial apparatus to be operated by a user, the tutorial apparatus comprising: a processor unit; at least one input device operationally coupled to the processor unit; a memory unit coupled to the processor unit, wherein the memory unit comprises code for allowing the user to enter user-selected study material into the tutorial apparatus using the at least one input device, code for forming a problem using the user-selected and user-entered study material, and code for providing assistance in solving the problem formed using the user-selected study material; and an output device coupled to the processor unit, wherein the output device is adapted to provide the assistance to the user to help the user solve the problem.

Another embodiment of the invention is directed to a computer readable medium comprising: code for allowing the user to enter user-selected study material into a tutorial apparatus using at least one input device in the tutorial apparatus; code for forming a problem using the user-selected, and user-entered study material; and code for providing assistance in solving the problem formed using the user-selected study material.

Another embodiment of the invention is directed to a method comprising: entering user-selected study material into a tutorial apparatus using at least one input device in the tutorial apparatus, wherein a problem is created from the user-selected study material; receiving assistance provided by a tutorial apparatus, wherein the assistance helps to solve the problem created from the user-selected study material; and solving the problem created from the user-selected study material using the assistance from the tutorial apparatus.

These and other embodiments of the invention are described in further detail below.

### BRIEF DESCRIPTION OF THE DRAWINGS

FIG. 1-1 shows a front plan view of a tutorial apparatus according to an embodiment of the invention.

FIG. 1-2 shows a bottom side view of a tutorial apparatus according to an embodiment of the invention.

FIGS. 2-1 to 2-35 show screen shots illustrating methods according to embodiments of the invention.

FIG. 3 shows a flowchart of a method according to an embodiment of the invention.

FIG. 4 shows a flowchart according to another embodiment of the invention.

FIG. 5 shows a block diagram of some components of an embodiment of the invention.

FIG. 6 shows a perspective view of another tutorial apparatus according to an embodiment of the invention.

### DETAILED DESCRIPTION OF THE INVENTION

Embodiments of the invention are directed to tutorial apparatuses, computer readable media, and methods. Other embodiments of the invention are also disclosed herein.

Embodiments of the invention can be used to assist the user in learning about any suitable subject. Suitable subjects include math, science, history, language arts, social studies, history (e.g., natural history), recognition of words, letters, shapes, colors, or symbols, phonics, etc.

Some embodiments of the invention can provide a user with step-by-step assistance with the user's computation-oriented math homework including addition, subtraction, multiplication, and division of whole numbers, decimals, fractions, pre-algebra, and algebra. Other embodiments of the invention can allow a user to enter a spelling list so that the user can master his own spelling list of words with an understanding of the proper spelling rules. This promotes learning instead of simple memorization. Lessons and questions for game play can be generated according to patterns present in the user's actual spelling list.

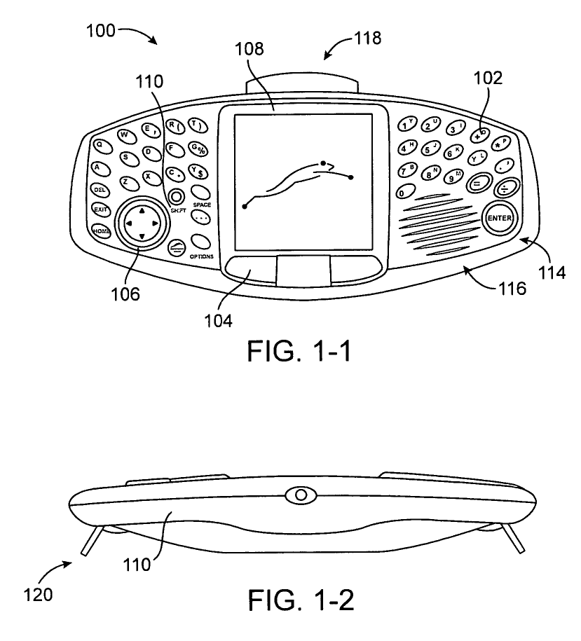

FIG. 1-1 shows a front plan view of a tutorial apparatus 100 according to an embodiment of the invention. As shown, the tutorial apparatus 100 is preferably self-contained, portable and hand-held. This allows the user to practice problems to be studied at any place and at any time.

It includes a housing 110, and a display device 108 on the housing 110. The display device 108 may be an LCD (liquid crystal display) device. A speaker 116 is also present in the housing 110 provides audio for the user. A data cartridge 118 is inserted into a slot in the housing 110 and can provide the tutorial apparatus with new software. Other data entry mechanisms such as a USB connector, flash memory cards, etc., can be used in other embodiments of the invention to provide new software for the tutorial apparatus.

A number of input devices are also on the housing 110. They include buttons forming an alphanumeric keyboard 102 in the tutorial apparatus 100. A directional pad 106 is also present on the left side of the housing 110, while an enter button 114 is on the right side of the housing 110. The direction pad allows a user to move a cursor on the display device 108 in a desired direction. Additional buttons 104 are below the display device 108 and these buttons 104 may be used to allow a user to select different options. Different options may be displayed on the display device 108 and above the buttons 104. These options may be presented by way of “soft” buttons displayed on the display device 108. Soft buttons are buttons that are formed using software that is run on the tutorial apparatus 100.

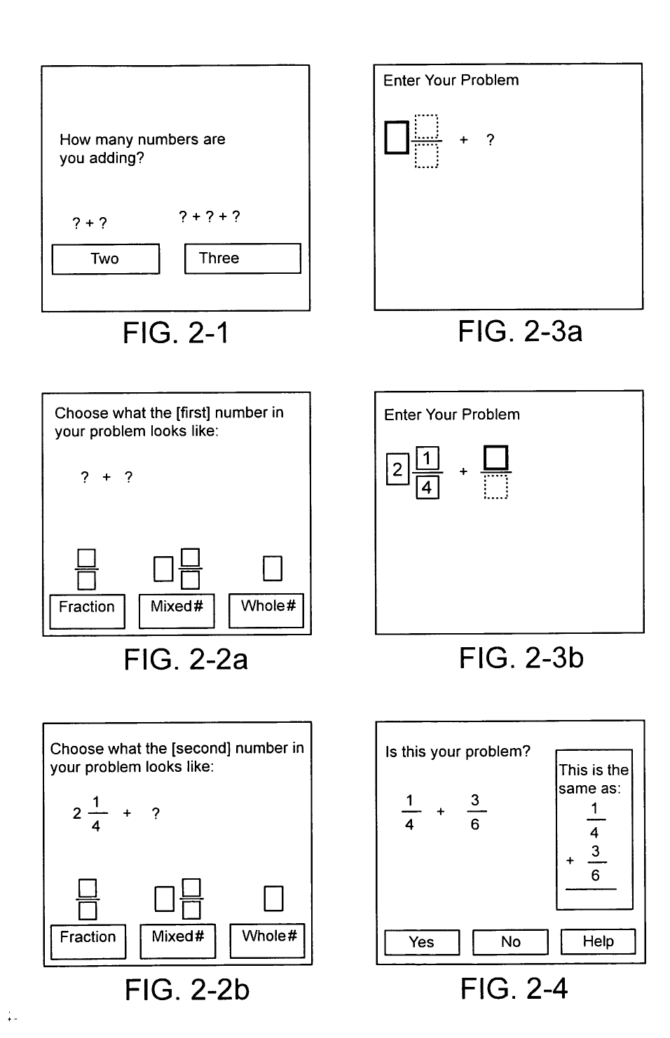

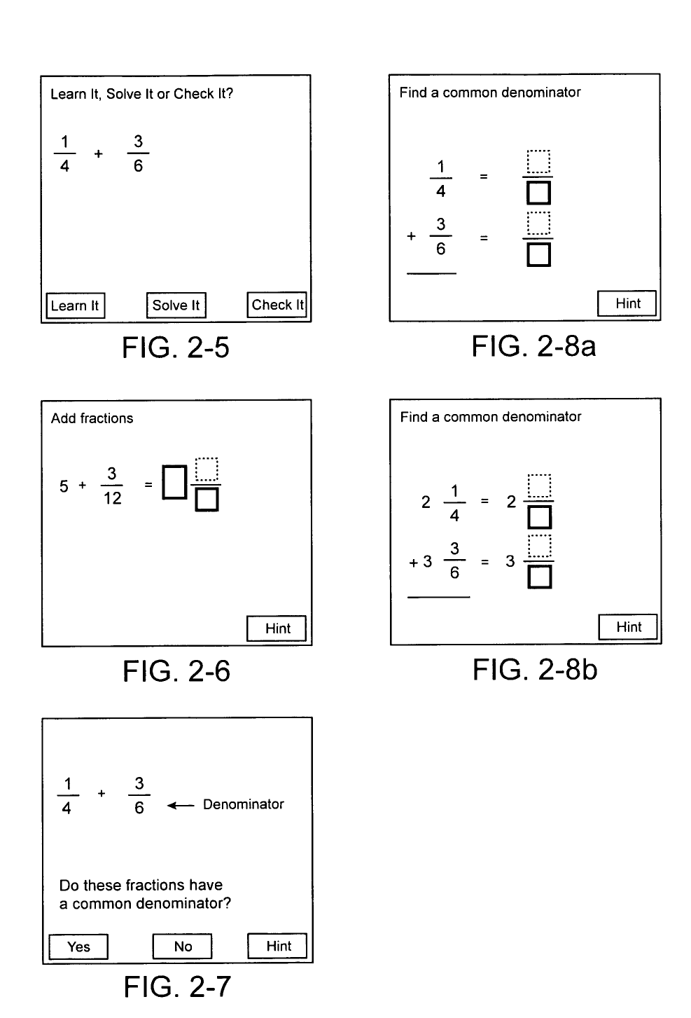

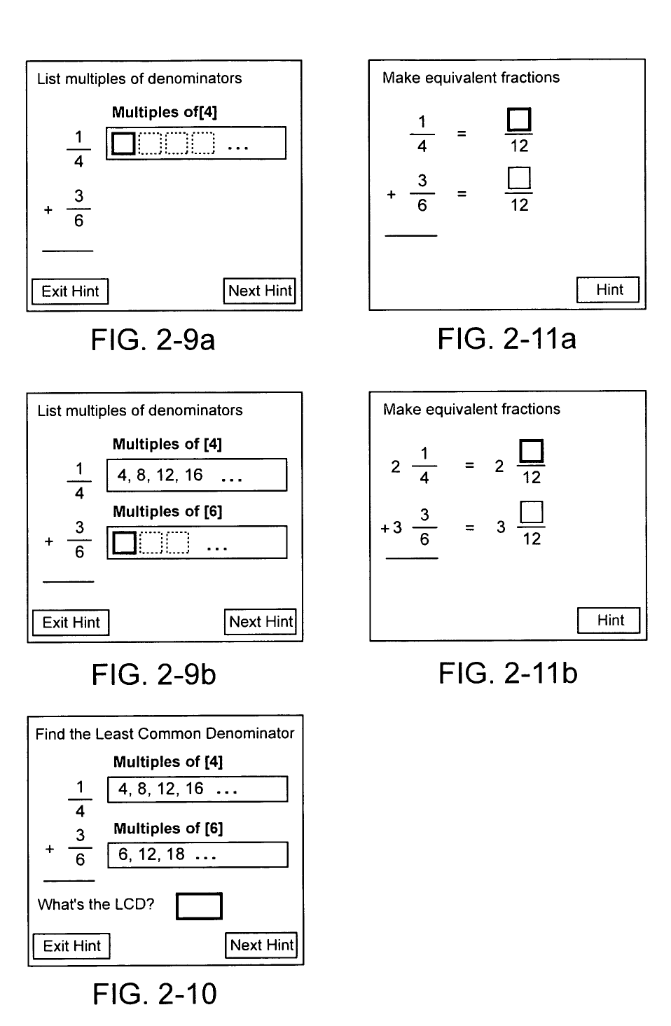

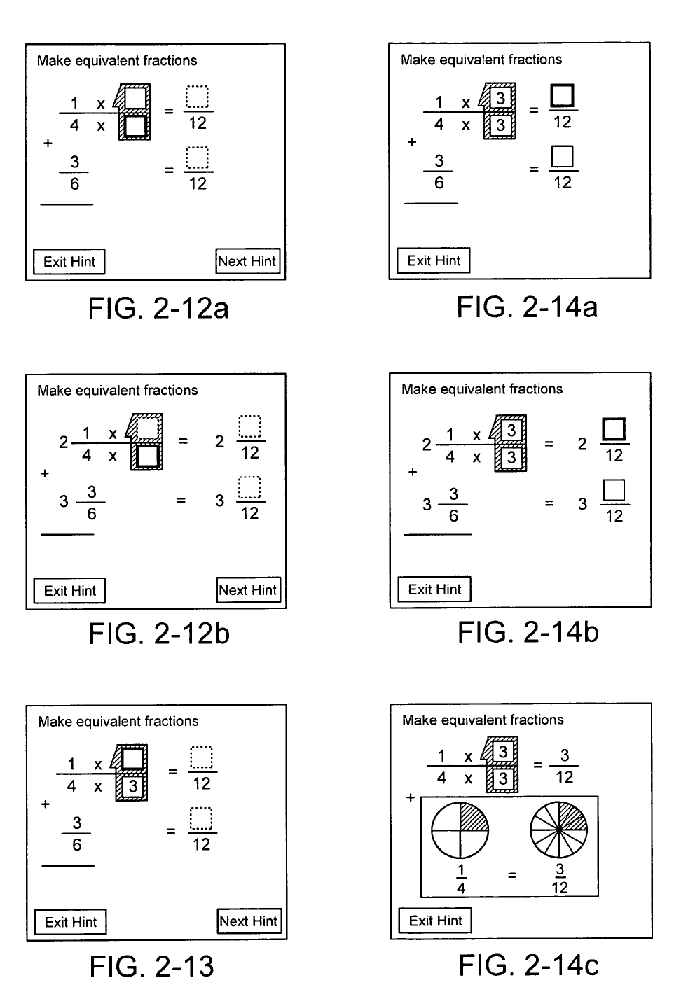

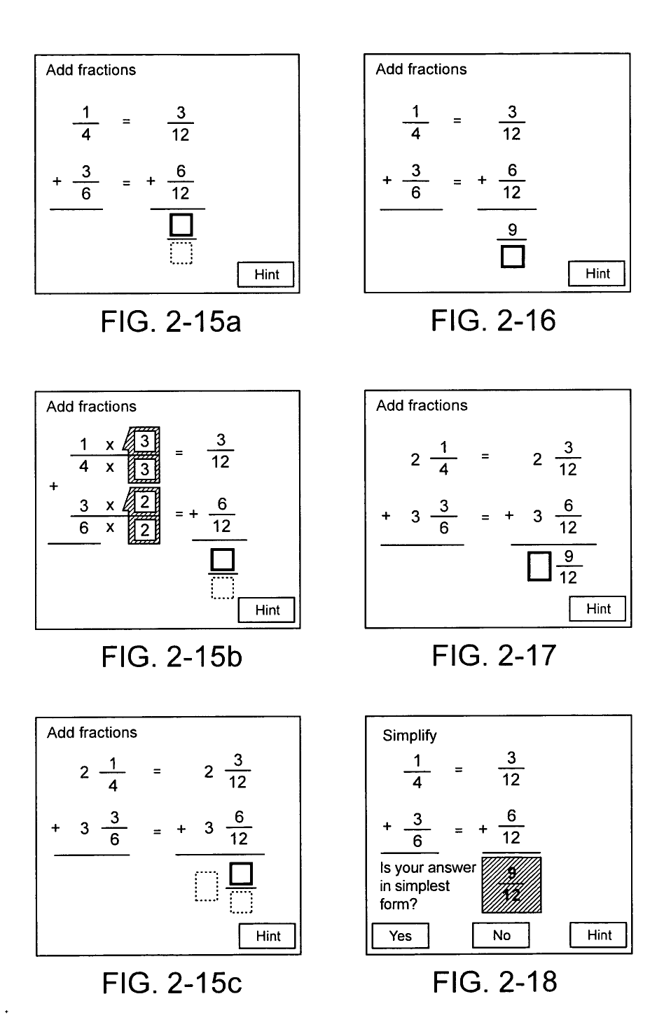

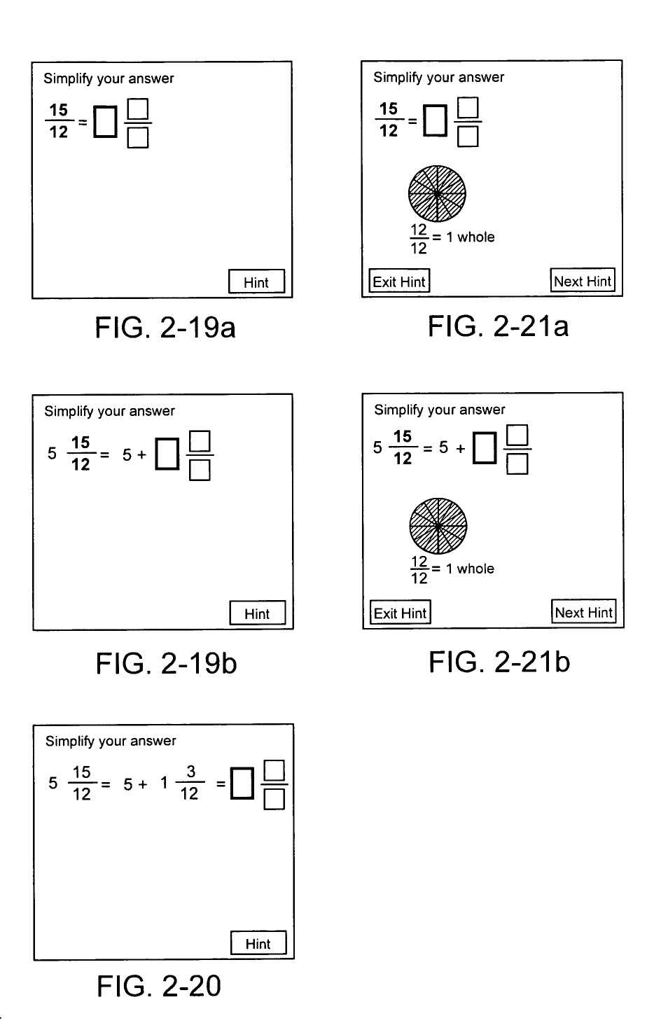

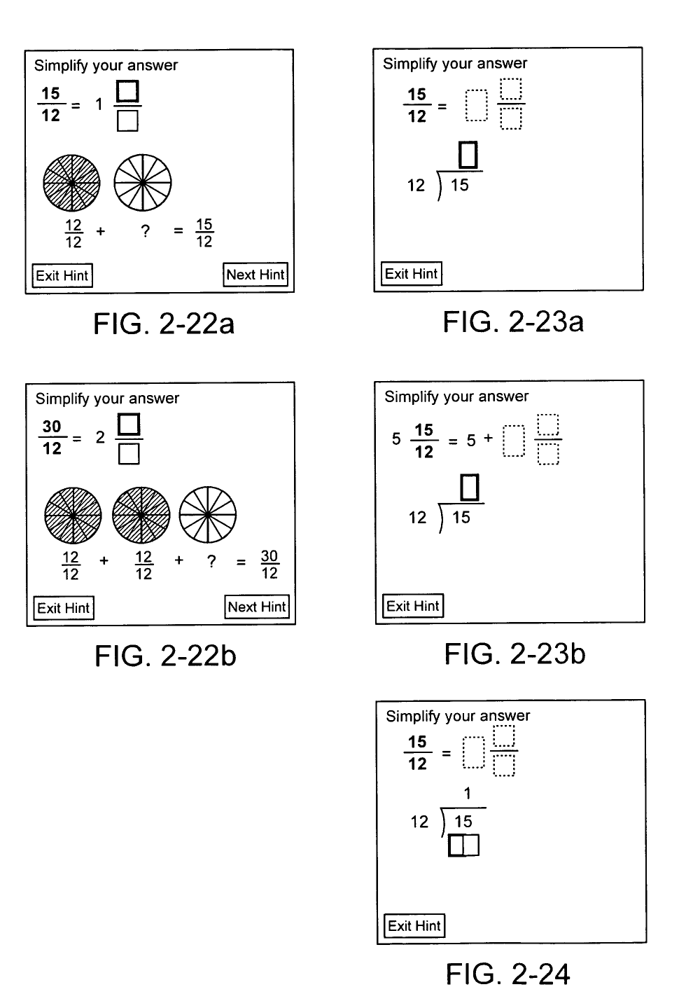

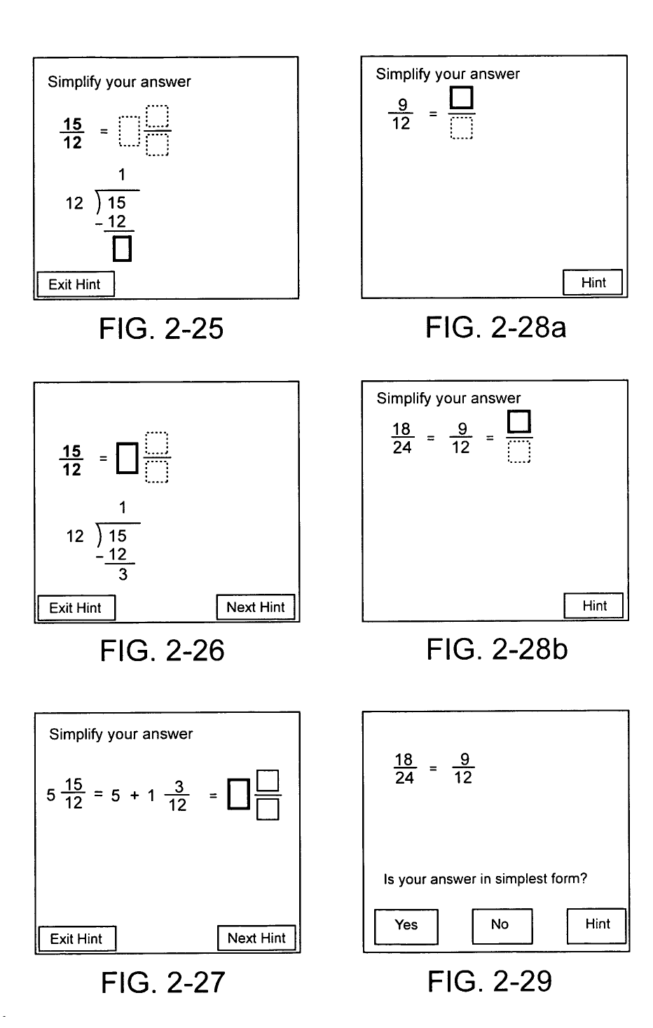

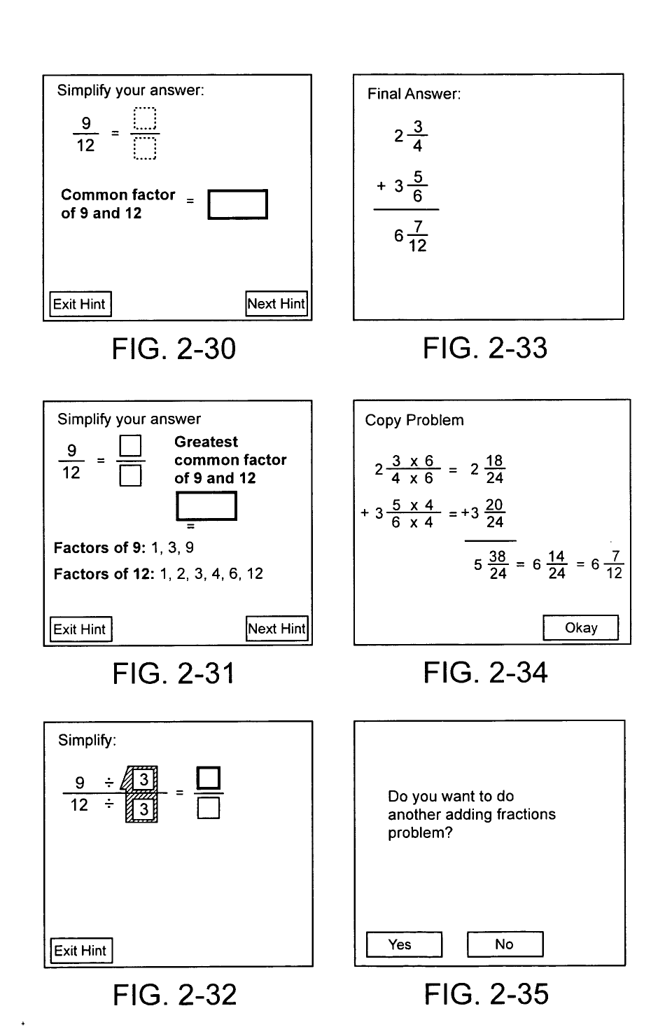

FIG. 1-2 shows a bottom side view of the tutorial apparatus 100. A shown, the tutorial apparatus 100 may include a plurality of wings 120. The wings 120 allow the tutorial apparatus 100 to be placed on a level surface. The wings 120 may fold out, and prevent the apparatus 100 from rocking back and forth. In some embodiments, the tutorial apparatus 100 may be tilted at a 30 degree angle toward the user so that the user can use the tutorial apparatus 100 in conjunction with books, and paper if desired.

One embodiment of the invention is directed to a method comprising entering a problem created from the user-selected study material, and then listening to assistance provided by a tutorial apparatus. The assistance is preferably step-by-step assistance that helps a user solve a problem created using the user-selected study material. The user then uses the tutorial apparatus to help solve a problem.

As used herein, “user-selected study material” includes words, numbers, symbols, etc. that are specifically selected by the user and that are used to form a problem or set of problems specifically for the user. The “user-selected study material” may also include problems specifically and individually selected by the user for study. This is opposed to specific sets of problems that may be pre-formed, and then selected in groups. For example, in embodiments of the invention, a user may have a homework assignment to learn how to spell a list of words. The user may use an input device to select individual words from a larger list of words residing on the tutorial apparatus to thereby mirror the list of words in the homework assignment. Games may be played and/or problems may be formed using this list of words. In another example, a user may have a specific set of math problems to study for school. As will be shown below, the numbers and mathematical operators for the math problems may be entered into the tutorial apparatus using an input device in the tutorial apparatus. In some embodiments, it may be possible to enter data into the tutorial apparatus using an external device such as an external keyboard. The math problems may constitute user-selected study material in this example, and the tutorial apparatus may form, but may not create a problem using the user-selected study material as in the spelling example described above.

Thus, in some embodiments of the invention, as will be shown below, before the user actually enters the study material into the tutorial apparatus and the tutorial apparatus forms the problem, the problem may not specifically exist in the tutorial apparatus. For instance, in the examples described with respect to FIGS. 2-1 to 2-35, problems such as ¼+3/6 may be formed by the user and may not be pre-stored in the memory unit of the tutorial apparatus and/or may not be pre-stored in the memory unit along with other problems specifically designed for use by that user. The problems may be generated by the user after the user enters one or more components of the problem into the tutorial apparatus.

Even though the problem was not pre-stored in the tutorial apparatus or even though the specific set of problems associated with the user is not pre-stored in the tutorial apparatus as a set of problems, assistance including hints may be provided to the user to help the user solve the newly user-created problem or problems. These hints may be provided to help the user solve the problem or problems without giving the user the answers to the problem or problems. In embodiments of the invention, the tutorial apparatus may be programmed to select the appropriate hints or assistance to help the user solve each problem after analyzing the problems identified by the user or after the user makes specific entries when trying to solve the problem. Thus, in contrast to the embodiments described in the Background Section above, embodiments of the invention can be used to help a user with the user's homework and can be used to provide step-by-step instruction for the user to solve those problems created using the user's study material.

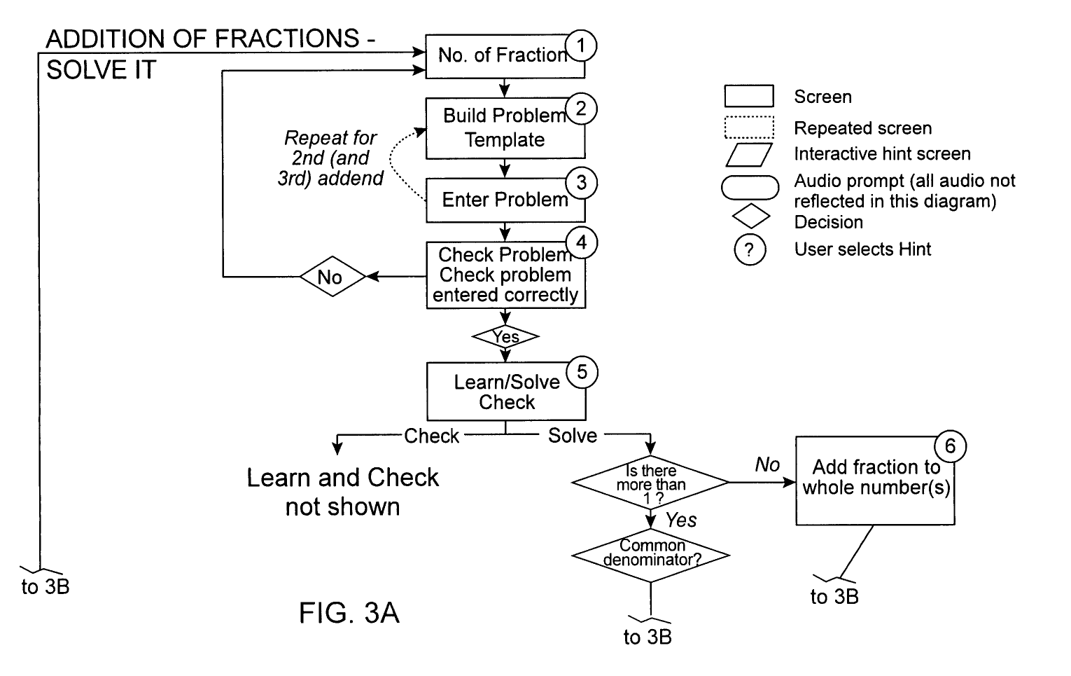

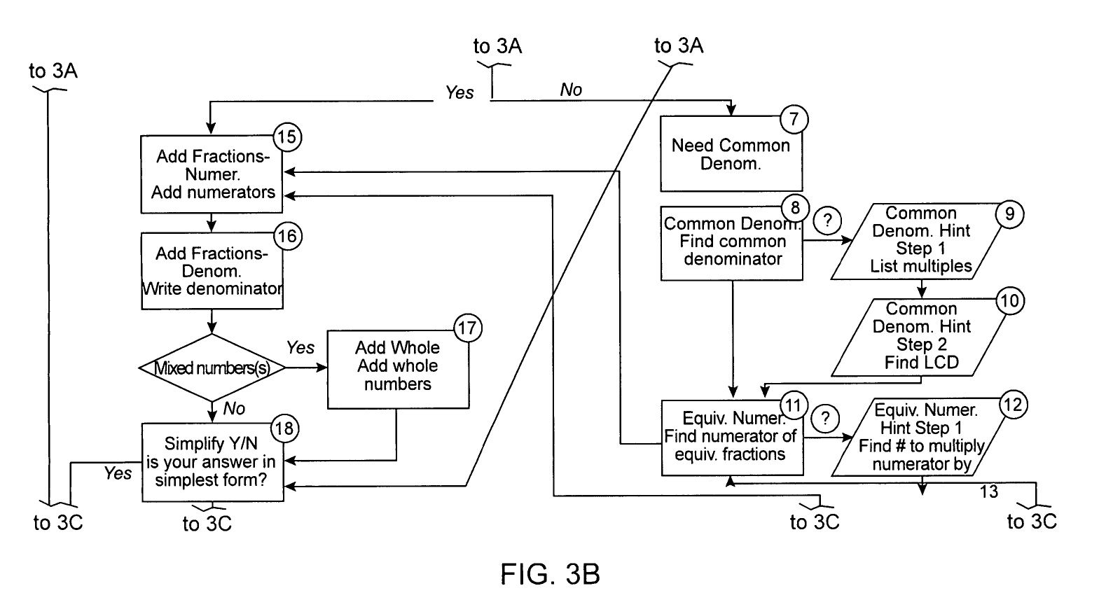

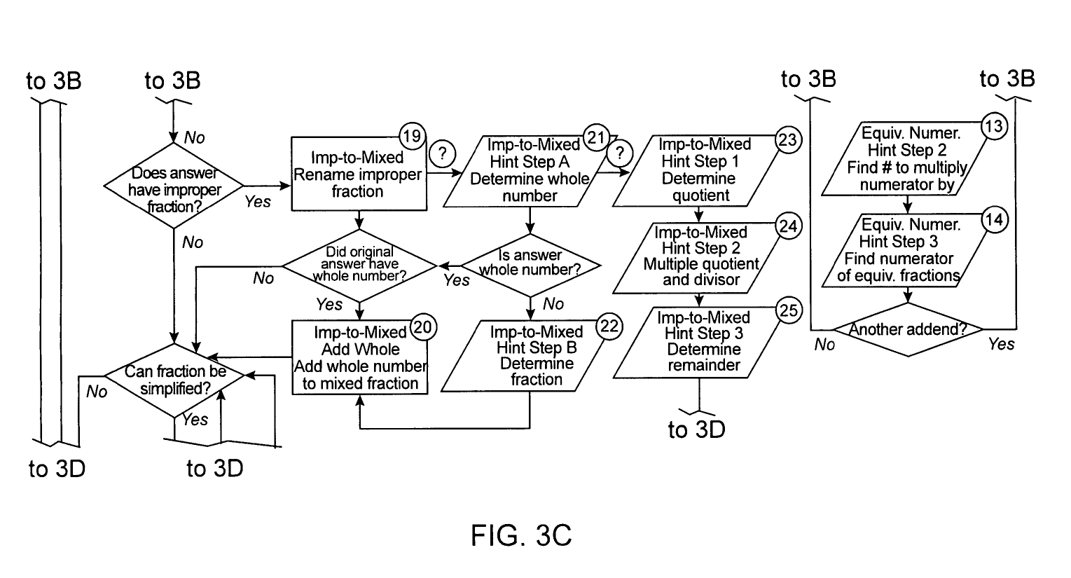

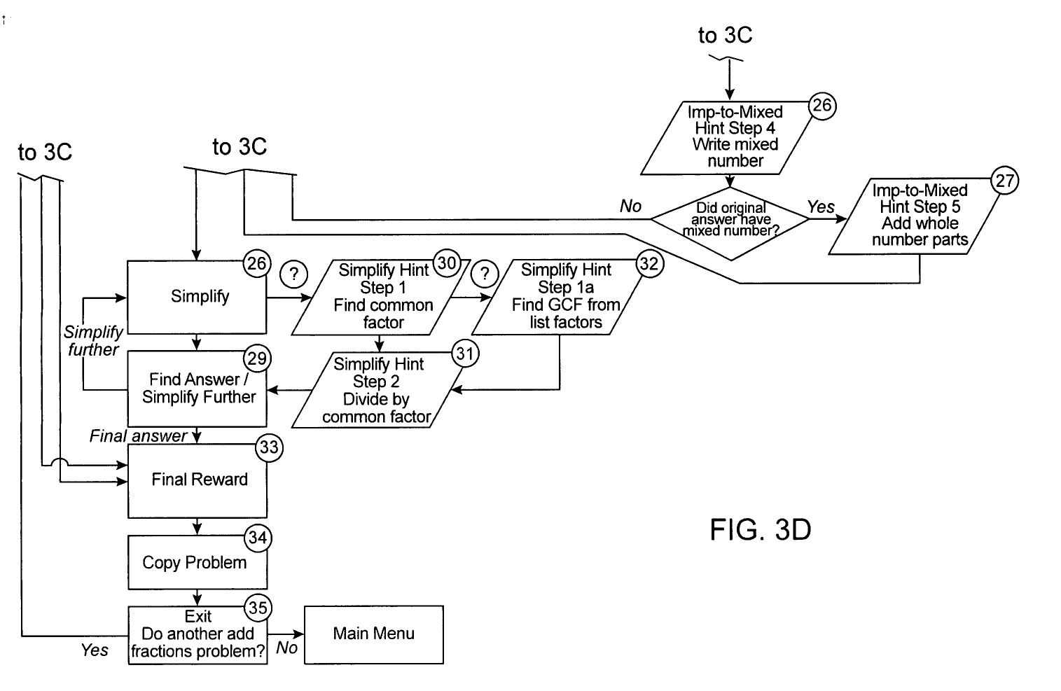

Embodiments of the invention may be described with reference to the screen shots shown in FIGS. 2-1 to 2-35, and with respect to the flowchart shown in FIG. 3. The steps 1-35 below refer to the steps shown in FIG. 3 and are exemplified in FIGS. 2-1 to 2-35. It is understood that embodiments of the invention need not include all steps shown in FIG. 3 and other embodiments of the invention may include more steps. In the described methods, assistance in the form of “hints” may be provided to the user during a multi-step process for solving a problem. Different hints are provided to the user depending on the particular problem being solved. In the steps described below, if the user enters a correct answer at a particular step in the problem solving process, the tutorial apparatus may provide a reward such as a clapping sound effect. If the user enters an incorrect answer, then the tutorial apparatus may provide the user with the answer for that particular step in the problem solving process.

In FIG. 2-1, the display device asks the user how many numbers are being added together (step 1). In this example, the user may choose from either two or three numbers to add together. The user may use the above noted “soft” buttons to make this selection. The tutorial apparatus may say “How many numbers are you adding? Press two fractions or three fractions.”

In FIGS. 2-2a and 2-2b, a problem template is built (step 2). In this example, the number of question marks and plus signs that are shown will depend on whether the user selects two or three fractions on the previous screen. This screen will be repeated for the second number, and if applicable, the third number. Soft buttons may allow the user to tell the tutorial apparatus that the user is entering a fraction, mixed number, or whole number. For example, the tutorial apparatus may say “Is the first number in your problem a fraction, a mixed number, or a whole number?” Audio such as this may be repeated for the second and third numbers.

In FIGS. 2-3a and 2-3b, the user can enter study material into the tutorial apparatus to form a problem to be solved (step 3). In this example, the user-selected study material may include numbers and mathematical operators for forming a problem or the problem itself. As shown in FIG. 2-3a, boxes appear based on the number type that was previously selected by the user. If previous addends have been entered, they should appear as shown in FIG. 2-3b, and they can be editable. As shown, some boxes may be highlighted for the user to inform the user that a particular number is to be entered into the box.

In FIG. 2-4, a check problem screen is shown (step 4). This allows the user to visually verify that the problem that has been entered is correct. The tutorial apparatus may say, “Is this your problem?” The user may also be asked on the display device if the problem that is shown is correct or incorrect, and the user may respond by selecting one of the soft buttons indicating “yes”, “no”, or “help”.

In FIG. 2-5, the user is presented with options to “learn it”, “solve it”, and “check it”. In the “learn it” mode, the user may learn the steps used to solve the displayed problem. The tutorial apparatus shows the user how to solve the shown problem in a step-by-step manner and may provide audio and visual instruction. In the “solve it” mode, the user uses the tutorial apparatus to solve the problem on the user's own. In the “check it” mode, the tutorial apparatus may check the problem and show the user the answer to the problem. The “solve it” mode will be described in further detail below. The tutorial apparatus may say, “Press ‘Learn it’ for a step-by-step lesson. To work at a quicker pace, press ‘Solve it’. If you just want to check your answer, press ‘Check it’.”

As shown in FIG. 3, the computer code in the tutorial apparatus then determines if there is more than one fraction. If there is not more than one fraction, then a screen like the one shown in FIG. 2-6 can be shown where a whole number is added to a fraction (step 6). As shown in FIG. 2-6, there is a “hint” soft button that can be selected to provide the user with an audio hint to help solve the displayed problem. In this example, the tutorial apparatus may say, “What's five plus three twelfths?” If the “hint” button is selected, then the tutorial apparatus may say “First, add the whole numbers. Then, write the fraction. After each box, press enter.”

If there is more than one fraction, then the tutorial apparatus determines if there is a common denominator. If there is no common denominator, then a screen like the one shown in FIG. 2-7 can be shown (step 7). As shown in FIG. 2-7, the tutorial apparatus asks the user, “Do these fractions have a common denominator?” Soft buttons indicating “yes”, “no” and “hint” are provided for the user to respond.

In FIGS. 2-8a and 2-8b, a common denominator is determined (step 8). When the user enters a number, it should appear in the denominator boxes for the second and, if applicable, third fractions as well as the first fraction. If the user does not understand how to find the lowest common denominator, the user can select the “hint” button. After selecting the “hint” button, the tutorial apparatus may say, for example, “To find a common denominator, multiply the denominators. What's 4 times 6?”.

Alternatively or additionally, after selecting the “hint” button, screens like those shown in FIGS. 2-9a and 2-9b may be shown (step 9). As shown, the user may be shown a number of boxes to fill in multiples of four, and then multiples of six. This can illustrate to the user that the lowest common denominator is twelve. During this hint process, the user may be prompted and/or encouraged with audio. For example, the user may be assisted by audio such as “What's four times one? What's four times two?”

In FIG. 2-10, the multiples of four and six are shown and the user is then quizzed on what the lowest common denominator is (step 10). Exit hint and next hint soft buttons may be provided for the user. Selecting the “next hint” button may cause audio such as “Look at the lists. The least common denominator is the smallest number that appears in both lists.” to sound from the tutorial apparatus. Selecting the “exit hint” button allows the user to exit the hint mode and return to the problem.

In FIG. 2-11a and 2-11b, the user is asked to make equivalent fractions. The tutorial apparatus may say, “Let's make equivalent fractions, we need numerators!” In this step, the previously determined lowest common denominator is displayed, while an active box is displayed for the numerator. A soft hint button is also shown. If it is selected and the original denominator equals a common denominator, then the tutorial apparatus may say “The denominator didn't change so the numerator stays the same.” If the original numerator does not equal a common denominator and/or if the user selects the hint button, then screens such as the ones in FIGS. 2-12a and 2-12b are shown to the user.

In FIGS. 2-12a and 2-12b, the user is asked to make equivalent fractions (step 12). The tutorial apparatus may then say, “Twelve is the least common denominator. To rename one fourth with the denominator 12, we need to multiply by a form of one. What's the right form of one?” After a period of inactivity, the tutorial apparatus may say, “Four times what number equals twelve?” If the user selects the “next hint” button, the apparatus may say “To find the missing factor in the denominator, divide twelve by four”.

In FIG. 2-13, another hint may be provided for the user (step 13) if the “next hint” button is selected. The tutorial apparatus may say, “To make this fraction equal to one, what goes in the numerator?” If the “Next Hint” button is selected, then the tutorial apparatus may say “A fraction is equal to one when the numerator and the denominator are the same. What goes in the numerator?”

In FIGS. 2-14a, 2-14b, and 2-14c, yet another hint may be provided for the user (step 14) if the “next hint” button is selected. Pie charts may be shown to illustrate fraction concepts. The tutorial apparatus may first say, “To make the equivalent fraction, multiply the numerators. What's one times three.” A hint such as “To make the equivalent fraction, multiply the numerators. What's one times three? One fourth and three twelfths are equivalent fractions.” may also be provided for the user.

Once common denominators for the problem are determined, as shown in FIGS. 2-15a, 2-15b, and 2-15c, the user then tries to add the numerators (step 15). The tutorial apparatus may say “Add the fractions!” If the user needs a hint, the tutorial apparatus may say, “When the denominators are the same, you can add the numerators. Add three plus six.”

In FIG. 2-16, the user is then prompted to write the denominator after the numerators are added (step 16). If the user needs a hint, the user can select the “hint” button, and the tutorial apparatus may say, “Remember, when you're adding fractions with a common denominator, the denominator stays the same.”

In FIG. 2-17, if the numbers being added together are mixed numbers, then the whole numbers are added together (step 17). The tutorial apparatus may say, “Add the whole numbers!” If the user needs a hint, the “hint” button may be selected, and the tutorial apparatus may say, “The whole numbers are written before the fraction. What's two plus three?”

In FIG. 2-18, the user is then prompted to verify that the answer is in simplest form (step 18). The tutorial apparatus may say “Is your answer in the simplest form?” “Yes”, “no”, and “hint” soft buttons are provided for user response. If the “hint” button is selected, and the numerator is equal to the denominator, then the tutorial apparatus may say “Is the numerator equal to the denominator? If so, it's an improper fraction.” If the answer is an improper fraction where the numerator is greater than the denominator, the tutorial apparatus may say, “It's an improper fraction and can be simplified.” If the answer can be simplified, but is not an improper fraction or if the answer can't be simplified, then the tutorial apparatus may say, “If you can divide the numerator and the denominator by a common factor other than 1, the fraction can be simplified.”

The foregoing example illustrates that different hints may be provided for different scenarios that the user may encounter when trying to solve a particular problem. In embodiments of the invention, the tutorial apparatus may be provided with a “hint tree” whereby different hints and different levels of hints may be provided to the user to help guide the user through the problem. Thus, the software in the tutorial apparatus can analyze the particular entries for the step in the problem that is being solved, and can therefore provide appropriate hints for the user.

In FIG. 2-19, the user is provided with a screen to turn an improper fraction into a mixed fraction (step 19). The tutorial apparatus may say, “We need the answer in its simplest form.” A “hint” button is shown.

If the user selects the “hint” button, as shown in FIG. 2-20, the user is provided with an example of how to convert an improper fraction into a mixed fraction (step 20). The user is shown that a whole number is added to a mixed fraction. The tutorial apparatus may say, “Now add the whole number from your original answer to the mixed number you created. After each box, press ‘enter”’. If the “hint” button is selected, the tutorial apparatus may say, “Add the whole numbers. Then write the fraction. After each box, press enter” if a whole number plus a mixed fraction is shown. If only whole numbers are shown, then the tutorial apparatus may provide a hint such as “What's five plus two? Type your answer and then press enter.”

If the original answer does not have a whole number, then a screen like the one shown in FIG. 2-21a is shown. The tutorial apparatus may say, “You have fifteen twelfths. It takes twelve twelfths to make a whole. How many wholes are in fifteen twelfths?” If the original answer had a whole number, then a screen like the one shown in FIG. 2-21b is shown (step 21). Hint buttons are shown in both screens.

If the user selects the hint button, then screens such as those shown in FIGS. 2-22a and 2-22b are shown (step 22) (if the whole number equals 1, and 2, respectively) so that the user can determine the whole number. The tutorial apparatus may say, “How many twelfths are left over?” If a right answer is provided, a correct sound effect may be played. If a wrong answer is provided, the tutorial apparatus may say, “There are three twelfths left over.” If the user selects the “next hint” button, the tutorial apparatus may say, “To make one whole, you used twelve twelfths out of fifteen twelfths. How many twelfths are left over?”

If the “next hint” button is selected, then the screen shown in FIG. 2-23a may be shown if the answer does not have a whole number, or screen shown in FIG. 2-23b may be shown if the answer has a whole number (step 23) so that the user can determine the quotient. The tutorial apparatus may say, “To find the whole number, divide the numerator by the denominator. How many times does twelve go into fifteen? That's the whole number.” An “exit hint” button is also shown to allow a user to exit the hint mode.

This process then continues as shown in FIGS. 2-24, 2-25, and 2-26 (steps 24, 25, and 26). FIG. 2-24 shows how to divide fifteen by twelve, and then how to determine a mixed number from an improper fraction. The tutorial apparatus may say, “Multiply one times twelve.” FIG. 2-25 shows how to determine a remainder in a division problem. The tutorial apparatus may say, “Subtract. What's fifteen minus twelve?” FIG. 2-26 shows the user how to write a mixed number. The tutorial apparatus may say, “Now that you know the quotient and the remainder, you can write the mixed number. What's the whole number?” If the “next hint” button is selected for the whole number, the tutorial apparatus may say, “Remember, the quotient is the whole number”. If the “next hint” button is selected for the numerator, the tutorial apparatus may say, “Remember, the remainder is the numerator.” If the “next hint” button is selected for the denominator, the tutorial apparatus may say, “The divisor is the denominator.” As illustrated by these and other screens, specific hints may be associated with each place for each number in a math problem.

If the original answer has a mixed number, then the user needs to add whole number parts of the problem together as shown in FIG. 2-27 (step 27). The user may be prompted, “Add the whole number from your original answer to the mixed number you created. After each box, press ‘enter’.” If the “next hint” button is selected and the problem includes a whole number added to a mixed number, the tutorial apparatus may say “First, add the whole numbers, and then write the fraction. After each box, press enter.” If the “next hint” button is selected and a whole number plus a whole number are being added together, the tutorial apparatus may say, “What's five plus one? Type your answer, and then press enter.

If, after step 26 the original answer did not have a mixed number, or if the user has completed step 27, then the tutorial apparatus determines if the fraction can be simplified. If the fraction can be simplified, then the tutorial apparatus proceeds to step 28. If not, then the tutorial apparatus proceeds to a final reward (step 33).

Fraction simplification is shown in FIGS. 2-28a and 2-28b (step 28). As shown in FIG. 2-28a, the user is asked to simply the answer. In FIG. 2-28b, the user is prompted again if the answer can be further simplified. The tutorial apparatus may say, “Simplify nine twelfths. After each box, press enter.”

In FIG. 2-29, the user is asked if the answer is in its simplest form (step 29). Soft buttons for “yes”, “no”, and “hint” may be provided for the user to answer the question. If the user selects the “hint” button, the tutorial apparatus may say “If you can divide the numerator by a common factor other than 1, you can simplify more.” If the hint button is selected, then the screen shown in FIG. 2-30 may be shown and the audio associated therewith may be played.

In FIG. 2-30, the user is asked to simply the answer “9/12” by asking the user to find the common factor of 9 and 12 (step 30). The tutorial apparatus may say, “To simplify, find a number that divides evenly into nine and twelve. Type the answer, and then press ‘enter”’. If the “next hint” button is selected, a hint such as “Check to see if the smaller number divides evenly into the larger number.” may be provided if the numerator divides evenly into the numerator.” A hint such as “If both numbers end in 0, try 10 as a common factor.” may be provided if both numbers end in zero. If both numbers are divisible by a particular number, then the tutorial apparatus may guide the user using that particular number. For example, if both numbers are divisible by three, then the tutorial apparatus may say (or show on the display device) “See if three is a common factor. A number is divisible by three if the sum of its digits is divisible by three.”

In FIG. 2-31, the tutorial apparatus shows a user how to simplify using a common factor (step 32). As shown, a box is provided for the user to provide the greatest common factor of 9 and 12. The tutorial apparatus may say, “Let's look at the factors of nine and the factors of twelve. Find the greatest common factor. That's the largest number that appears in both lists. Type your answer. Then press ‘enter’.” If the “next hint” button is selected, the tutorial apparatus may say, “Look at the lists. The greatest common factor is the largest number that appears in both lists.”

Then, a screen like the one shown in FIG. 2-32 may be shown to show a user how to divide the numerator and the denominator by a common factor such as the greatest common factor (GCF) (step 31). The tutorial apparatus may say, “Now divide the numerator and the denominator by the greatest common factor. That's like dividing by one. What's nine divided by three?“An ” exit hint” button is provided to allow a user to exit the hint mode.

In FIG. 2-33, the user is provided with a final reward screen (step 33). The tutorial apparatus may say, “Two and three fourths plus three and five sixths equals six and seven twelfths.

In FIG. 2-34, the user is shown a screen with a problem and is invited to copy the problem onto a homework sheet (step 34). The tutorial apparatus may say, “Copy your work onto your paper homework paper. When you're finished, press ‘okay’.” When the user is done, the user can select the “okay” button.

In FIG. 2-35, the user is shown a screen and is asked if another problem is desired, and soft buttons for “yes” and “no” can be provided (step 35). As shown in FIG. 3, if the user answers yes, the process is repeated, if the user answers no, then the user is returned to the main menu.

As illustrated by the FIGS. 2-1 to 2-35, and FIG. 3, embodiments of the invention allow a user to input a customized math problem into the tutorial apparatus. The user may receive specific hints at each stage of the problem to help the user learn about how to solve the problem and about the mathematical concepts that are used to solve the problem. It is apparent that although fraction problems are described in detail, embodiments of the invention can be applied to any type of mathematical problem including addition, subtraction, multiplication, division, trigonometry, algebra, calculus, etc. In embodiments of the invention, the user (and also the tutorial apparatus) can create a problem using user selected study material, and can receive hints at each stage of the problem to help the user solve the problem and understand the concepts behind the solving of the problem.

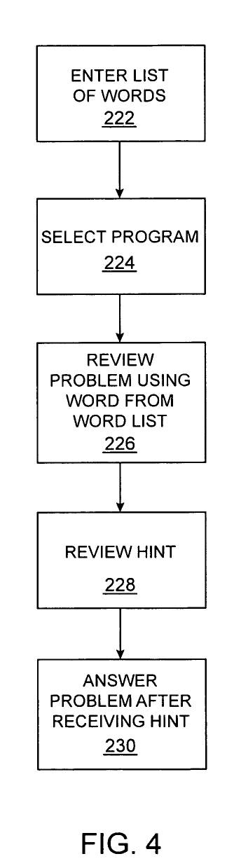

Embodiments of the invention may also be used to learn about non-math subjects such as spelling. FIG. 4 shows a flowchart for an embodiment where the study material is a list of words selected by the user. This list of words can be used to create problems that are solved by the user. The problems may be used in a game or other fun learning environment.

Referring to FIG. 4, a list of words is entered into the tutorial apparatus (step 222). The list of words may be entered in any suitable manner. For example, the user may select words already stored in a memory unit in the tutorial apparatus. Alternatively, the user may load a user-selected word list into the tutorial apparatus, after selecting the individual words.

Then, the user may select a program to use with the word list (step 224). The program could be a game, and can present the words to the user in any suitable manner. The program may generate problems using the words in the word list. For example, the user may be quizzed on the words in the word list in a “scramble” type game, or the words may be presented with other words with “distracters” so that the user can learn to identify the words in the word list from other similar words. “Distracters” are described in further detail below.

The program is then run using the user-selected word list, and the user reviews a problem using a word from the selected word list (step 226). Then, hints (in audio or visual form) are provided to the user to help the user solve problems using the words in the user-selected word list (step 228). The user may thereafter answer the problem after receiving the hint (step 230).

As noted above, distracters can be used in a spelling game using problems created from user-selected study material. Whenever possible, it is desirable to be as intelligent as possible in providing distracters, or wrong answers, that are plausible to the user who is learning American English. A combination of pre-defined, static information and software can be used to generate distracters “on-the-fly”. In embodiments of the invention, approximately 16,000 words can be linked to over 150 spelling rules and patterns with tags that apply to specific letters in each word. Each of the letters tagged with the rules and patterns can have “smart” distracters associated with them. For example, the letters “ei” in weight make the long-A sound. A smart distracter for “ei” in this instance would be “ai”, because together they can also make the long-A sound.

When a word has been pre-tagged to the rules and patterns, the distracters associated with the relevant rules and patterns are used as the distracters in the program. When a word has not been pre-tagged, code in the memory unit in the tutorial apparatus can automatically search for letters that comprise a rule or pattern, and then apply the appropriate distracters. An algorithm takes into account relative weights that have been pre-assigned and determines the order in which the rules and patterns are determined. For example, each rule or pattern often has up to three or four distracters. Which distracter is used is also determined by the algorithm that takes into account relative weights that have been assigned to each of the distracters for a particular rule or pattern. The relative weights may be assigned beforehand. For each program, the application of distracters can be further refined to meet the needs of the game. For example, in an exemplary game, if a word contains two letters, the distracters used for this word must have the same number of letters. In contrast, in another game, the number of letters is not factor in choosing a distracter. An exemplary screen showing distracters may show a list of words including, for example, “retrieve”, “retrieve”, “retrieve”, and “retrieve”. The user is then asked to select the correctly spelled word for the word “retrieve” from among the distracters. The use of distracters in spelling games can help the user develop his or her language skills.

Illustratively, in one embodiment, a user may select a number of words from a global word list in the tutorial apparatus to form a user-selected list that includes words from the user's current homework assignment. The user's homework assignment may be to learn how to spell the words in the list. The user may then select a program to use with the word list. A program for a game such as “jumble” can be played with the word list. The tutorial apparatus selects a word and the letters of the word are randomly mixed so that the user can unscramble the word. If the user selects the “hint” button, audio for the word in question may be played, or the tutorial apparatus may provide the order of the first few letters of the word to provide the user with a hint.

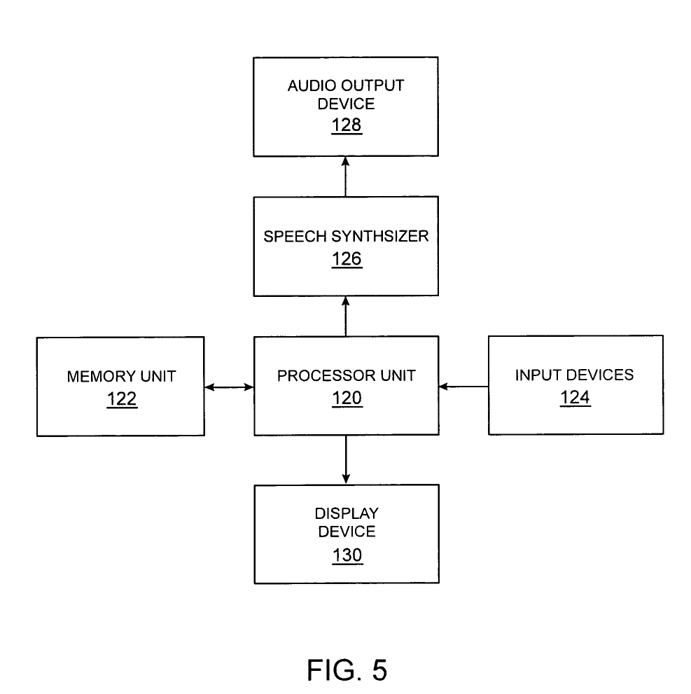

FIG. 5 shows a block diagram illustrating some electronic components that can be used in embodiments of the invention. FIG. 5 shows a processor unit 120. The processor unit 120 may be operationally coupled to a display device 130, input devices 124, a memory unit 122, a speech synthesizer 126, and an audio output device 128.

The display device 130 may be an LCD (liquid crystal display), or a display including LEDs. It may also include a touch-sensitive display of type used in many commercially available in personal digital assistants (PDAs). In these embodiments, a stylus or a finger may be used to provide data input by a user instead of or in addition to using mechanical buttons that are provided on the tutorial apparatus.

The input devices 124 may comprise buttons associated with switches in some embodiments. Alternatively or additionally, user-selected study materials and/or user-defined problems may be provided to the apparatus in other ways. For example, a microphone may be used to input data into the tutorial apparatus, and appropriate commercially available speech-to-text software can be used to enter data into the tutorial apparatus. One such commercially available software program is sold under the tradename Dragon Naturally Speaking®.

The memory unit 122 may comprise any suitable computer readable medium that operates using any optical, electrical, or magnetic data storage mechanism. The memory unit may comprise one or more of volatile or non-volatile memory devices that may be internal and/or external to the housing of the tutorial apparatus. For example, the memory unit 122 may comprise an internal RAM (random access memory) in combination with an external flash memory or ROM chip, cartridge, or stick.

The memory unit 122 may comprise a computer readable medium that may exist on one or more memory devices. Any of the functions or methods described in this application can be embodied as code on a computer readable medium. For example, code for performing any of the steps in FIGS. 3 and 4 can be created by one of ordinary skill in the art, and this code may be stored on the computer readable medium. Code for the operating system for the tutorial apparatus may also be stored on the computer readable medium. In addition, code for any of the functions or methods described herein may be created using any suitable programming language including Fortran, C, C++, etc.

The audio output device 128 may comprise, for example, a speaker, an earphone jack, etc. The speech synthesizer 126 may comprise any suitable commercially available speech synthesizers. These components may be electrically coupled to the processor unit 120 and may include or be coupled to any other amplifiers, and converters that are necessary to produce synthesized speech that can guide the user when using the tutorial apparatus.

Although the components in FIG. 5 are shown as separate functional blocks, it is understood that these functional blocks may be physically embodied many separated by operationally coupled devices or a single device. For example, chips that have a processor, speech synthesizer, and memory unit are commercially available from SunPlus, Inc.

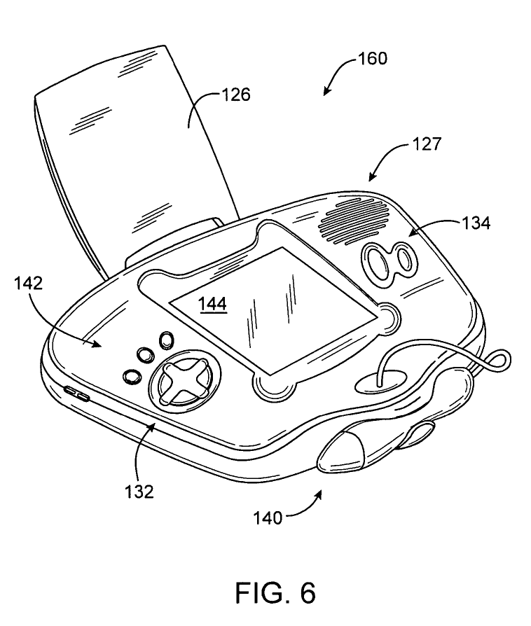

FIG. 6 shows a perspective view of a tutorial apparatus embodiment that has a different configuration that the embodiment shown in FIGS. 1-1 and 1-2. In FIG. 6, the tutorial apparatus 160 includes a housing 142, a display device 144 including a touch sensitive-display on the housing 142, a stylus 140 for use in making selections on the touch-sensitive display, and a speaker 127. A direction pad 132 is on the left side 132 of the tutorial apparatus 160, and an enter and hint buttons 134 can be on a right side of the tutorial apparatus 160. A cover 126 can be used to protect the display device 144.

Further details regarding the tutorial apparatus in FIG. 6 can be found in U.S. patent application Ser. Nos. 10/775,830, 10/776,012, 60/446,829, and 60/512,326, which are herein incorporated by reference in their entirety for all purposes. It is understood that any of the above-described functions can be performed using the apparatus shown in FIG. 6. Although this embodiment does not show a keyboard for data entry, suitable data entry can occur by displaying a keyboard on the display device 144 or a separate external keyboard (not shown) could be connected to the housing 142 of the tutorial apparatus 160 to provide data input.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

Also, it should be understood that the embodiments of the invention as described above can be implemented in the form of control logic using computer software in a modular or integrated manner. Based on the disclosure and teachings provided herein, a person of ordinary skill in the art will know and appreciate other ways and/or methods to implement the present invention using any suitable combination of hardware and software.

All patent applications, patents, and publications mentioned above are herein incorporated by reference in their entirety for all purposes. None of them, and none of the descriptions in this application are admitted to be prior art.

1. A tutorial apparatus to be operated by a user, the tutorial apparatus comprising:
a processor unit;
at least one input device operationally coupled to the processor unit;
a memory unit coupled to the processor unit, wherein the memory unit comprises code for allowing the user to enter user-selected study material into the tutorial apparatus using the at least one input device, code for forming a problem using the user-selected, and user-entered study material, and code for providing assistance in solving the problem formed using the user-selected study material; and
an output device coupled to the processor unit, wherein the output device is adapted to provide the assistance to the user to help the user solve the problem.

2. The tutorial apparatus of claim 1 wherein the problem is a math problem.

3. The tutorial apparatus of claim 1 wherein the problem is a spelling problem.

4. The tutorial apparatus of claim 1 wherein the problem uses fractions.

5. The tutorial apparatus of claim 1 wherein the at least one input device comprises buttons including numbers and mathematical symbols.

6. The tutorial apparatus of claim 1 wherein the memory unit comprises code for providing different hints for different parts of the problem.

7. The tutorial apparatus of claim 1 further comprising a directional pad on a left side of the tutorial apparatus and an enter button on the right side of the tutorial apparatus.

8. The tutorial apparatus of claim 1 wherein the tutorial apparatus is hand held, and comprises a display device operatively coupled to the processor unit.

9. A computer readable medium comprising:
code for allowing the user to enter user-selected study material into the tutorial apparatus using at least one input device in a tutorial apparatus;
code for forming a problem using the user-selected, and user-entered study material; and
code for providing assistance in solving the problem formed using the user-selected study material.

10. The computer readable medium of claim 9 wherein the problem is a math problem.

11. The computer readable medium of claim 9 wherein the problem is a spelling problem.

12. The computer medium of claim 9 wherein the problem is a spelling problem and wherein the computer readable medium further comprises code for generating spelling distracters.

13. The computer readable medium of claim 9 wherein the assistance is step-by-step assistance that helps the user solve the problem.

14. The computer readable medium of claim 9 wherein the problem uses fractions.

15. A method comprising:
entering a problem into a tutorial apparatus using at least one input device in the tutorial apparatus, wherein the problem is created from the user-selected study material;
receiving assistance provided by a tutorial apparatus, wherein the assistance helps to solve the problem created from the user-selected study material; and
solving the problem created from the user-selected study material using the assistance from the tutorial apparatus.

16. The method of claim 15 wherein the problem is a math problem or a spelling problem.

17. The method of claim 15 wherein receiving assistance comprises listening to the assistance.

18. The method of claim 15 wherein the user-selected study material comprises a word that is selected by the user, and wherein the problem includes the word selected by the user and a plurality of words including distracters.

19. The method of claim 15 wherein the assistance comprises step-by-step assistance that helps the user solve the problem.

20. The method of claim 15 wherein the tutorial apparatus is portable.
